(19) United States
(12) Patent Application Publication
(10) Pub. No.: US 2026/0366367 A1
(43) Pub. Date: Nov. 19, 2026

(54) LIGHT BLOCKING PRIVACY SHEET FOR WINDOW PANE

(71) Applicant: NAM CORPORATION, Osaka (JP)

(72) Inventor: Nobuyoshi TANAKA, Osaka (JP)

(73) Assignee: NAM CORPORATION, Osaka (JP)

(21) Appl. No.: 19/104,384

(22) PCT Filed: Aug. 4, 2023
(86) PCT No.: PCT/JP2023/028512

§ 371 Date: Jan. 26, 2026

(30) Foreign Application Priority Data
Aug. 29, 2022 (JP) 2022-135580
Oct. 7, 2022 (JP) 2022-162158

(51) Int. Cl. E06B 9/24; E06B 3/67

(52) U.S. Cl. CPC E06B 9/24; E06B 3/6715

(57) ABSTRACT

Provided is a light blocking privacy sheet for a window pane that has appropriate light blocking properties and privacy protection function, higher design flexibility, and design properties that can be perceived no matter whether it is during the day or night and no matter whether the sheet is seen indoors or outdoors. A light blocking privacy sheet 1 configured to be attached to a surface of a window pane G, comprises: an opaque or translucent first sheet 10 configured to be attached to the window pane G; a second sheet 20 layered on a portion of the first sheet 10, wherein the second sheet 20 has a shading ratio higher than that of the first sheet 10, and lightness and darkness of the first sheet 10 and the second sheet 20 appear to be reversed, depending on a difference between indoor lightness and outdoor lightness.

### TECHNICAL FIELD

The present invention relates to light blocking privacy sheets that are attached to the surface of window panes.

### BACKGROUND ART

It is conventionally known that a light blocking sheet may be attached to a window pane of a house, office building, or the like in order to block light or protect privacy (see, for example, Patent Document 1).

Patent Document 1 describes a light blocking sheet in which a polyvinyl chloride resin sheet layer is integrally provided on top of one surface of a polyester film on which a translucent metal vapor deposition film such as an aluminum vapor deposition film is formed, and an adhesive layer having a weak adhesive strength is provided on the polyvinyl chloride resin sheet layer.

The light blocking sheet thus configured has a silver color or only one other color of the metal vapor deposition film, and therefore, has shortcomings in terms of design properties. In addition, the film on which a metal vapor deposition film such as an aluminum vapor deposition film is formed has glare of a silver color or the like, resulting in unpleasant or unnatural feeling.

To address such problems, a decorative sheet that has a light blocking function and improved decorative properties has been proposed (see, for example, Patent Document 2).

Patent Document 2 describes a decorative sheet in which a print layer is provided on one surface of a multilayer film body including a number of films stacked. Furthermore, a colored transparent first adhesive layer and a colorless transparent resin film layer are successively stacked, and the light transmittance of the first adhesive layer is set to 3 to 70%, whereby appropriate light blocking properties are achieved.

The decorative sheet thus configured has a light blocking function and allows printing of any character or graphic on the print layer, and therefore, has improved decorative properties compared to conventional light blocking sheets having only a light blocking function. In addition, a metal vapor deposition film is not used for light blocking, and therefore, it is possible to avoid unpleasant or unnatural feeling which would otherwise be caused by glare of a metal color or the like.

### CITATION LIST

### Patent Literature

Patent Document 1: Japanese Utility Model Application Publication No. 57-050341
Patent Document 2: Japanese Unexamined Patent Application Publication No. 2004-82373

### SUMMARY OF INVENTION

### Technical Problem

The decorative sheet described in Patent Document 2 has the above advantages. However, the decorative sheet includes the colored transparent first adhesive layer and the colorless transparent resin film layer, i.e., all layers of the sheet are transparent, except for the print layer, which means that no privacy protection is taken into consideration. Furthermore, in the decorative sheet described in Patent Document 2, a flowable adhesive agent is applied to form the first adhesive layer in order to cover printed characters and graphics, and the resin film layer is formed on the first adhesive layer. Thus, it is not assumed that the user may subsequently change the design of the sheet so as to cause the sheet to fit the size of a window pane or the user's preference, disadvantageously resulting in low design flexibility. Furthermore, the decorative sheet described in Patent Document 2 exhibits rainbow-like colors and deep muted colors due to transmitted light and reflected light, resulting in higher decorative properties. However, the decorative properties may decrease during the night, during which it is dark.

With the above problems in mind, the present invention has been made. It is an object of the present invention to provide a light blocking privacy sheet for a window pane that has appropriate light blocking properties and privacy protection function, higher design flexibility, and design properties that can be perceived no matter whether it is during the day or night and no matter whether the sheet is seen indoors or outdoors.

### Solution to Problem

A characteristic feature of a light blocking privacy sheet for a window pane according to the present invention that addresses the above problems is a light blocking privacy sheet configured to be attached to a surface of a window pane, the sheet comprising:
an opaque or translucent first sheet configured to be attached to the window pane; and
a second sheet layered on a portion of the first sheet, wherein
the second sheet has a shading ratio higher than that of the first sheet, and
lightness and darkness of the first and second sheets appear to be reversed, depending on a difference between indoor lightness and outdoor lightness.

According to the light blocking privacy sheet for a window pane thus configured, appropriate light blocking properties and privacy protection function can be obtained by attaching the first sheet, which is opaque or translucent, to a window pane. A shape and position of the second sheet, which is provided on top of the first sheet, can be arbitrarily determined by the user if necessary, resulting in an improvement in design flexibility. In addition, the second sheet has a shading ratio higher than that of the first sheet. Therefore, when seen indoors during the day, during which it is lighter outdoors than indoors, the first sheet appears whitish in color due to the sunlight. In addition, because the second sheet has a shading ratio higher than that of the first sheet, the second sheet appears blackish in color. Furthermore, when seen indoors during the night, during which it is lighter indoors than outdoors, the first sheet appears blackish in color, and the second sheet appears white or the like in color, which is the original color. Thus, lightness and darkness of the first and second sheets can appear to be reversed, depending on a difference between indoor lightness and outdoor lightness. In addition, lightness and darkness of the first and second sheets appear to be reversed between the day and night when seen outdoors. Therefore, design properties can be perceived no matter whether it is during the day or night and no matter whether the sheet is seen indoors or outdoors.

In the light blocking privacy sheet for a window pane according to the present invention,
the shading ratio of the first sheet is preferably 30 to 85%.

According to the light blocking privacy sheet for a window pane thus configured, the shading ratio of the first sheet is in the above appropriate range, resulting in appropriate light blocking properties. In addition, because the shading ratio is in the above range, the first sheet becomes whitish due to the sunlight during the day, and becomes blackish due to a change in the color of the outside during the night, for example. Thus, design properties that provide different appearances during the day and night can be perceived.

In the light blocking privacy sheet for a window pane according to the present invention,
the shading ratio of the second sheet is preferably at least 90%.

According to the light blocking privacy sheet for a window pane thus configured, the shading ratio of the second sheet is at least 90%. Therefore, in the case in which a surface of the second sheet has a light color such as white, when the second sheet is seen indoors, the second sheet transmits substantially no sunlight and therefore appears dark in color such as dark gray or black during the day, and appears white or the like in color, which is the original color, without being affected by a change in the color of the outside during the night. As a result, lightness of darkness can differ between the second sheet and the first sheet.

In the light blocking privacy sheet for a window pane according to the present invention,
the first sheet preferably has any of a cloth, nonwoven fabric, synthetic resin film, synthetic resin sheet, and synthetic resin plate.

According to the light blocking privacy sheet for a window pane thus configured, the first sheet has any of a cloth, nonwoven fabric, synthetic resin film, synthetic resin sheet, and synthetic resin plate. Therefore, the first sheet is opaque or translucent, resulting in a privacy protection effect, i.e., a privacy protection function can be exhibited. Furthermore, the first sheet does not include a layer of metal vapor deposition film such as an aluminum vapor deposition film. Therefore, unpleasant or unnatural feeling caused by glare of a silver color or the like can be avoided, resulting in a muted color such as white.

In the light blocking privacy sheet for a window pane according to the present invention,
the second sheet is preferably formed in the shape of a picture, graphic, pattern, and/or character.

According to the light blocking privacy sheet for a window pane thus configured, the second sheet is formed in the shape of a picture, graphic, pattern, and/or character. Therefore, the user can arbitrarily change a shape, position, and combination of the second sheet(s). In addition, when seen indoors during the day, the first sheet appears whitish in color and the second sheet appears blackish in color, resulting in design properties that provide figures in shadow play, for example. Furthermore, when seen indoors during the night, the first sheet appears blackish in color and the second sheet appears whitish in color, resulting in design properties that provide figures in shadow play in a light-dark reversal manner, for example. Furthermore, in typical shadow play, when a picture is placed on one side, is illuminated from the back thereof, and is seen from the other side, only one of the sides can exhibit design properties. In the light blocking privacy sheet for a window pane according to the present invention, the first sheet appears blackish in color and the second sheet appears whitish in color when seen outdoors during the day, while the first sheet appears whitish in color and the second sheet appears blackish in color when seen outdoors during the night. Therefore, design properties can be perceived both indoors and outdoors, and a picture of the like having a clear contour can be seen both indoors and outdoors.

### BRIEF DESCRIPTION OF DRAWINGS

FIG. 1 is a cross-sectional view of a light blocking privacy sheet for a window pane according to an embodiment of the present invention.

FIG. 2 illustrates comparative photographs of a light blocking privacy sheet for a window pane according to an embodiment of the present invention that are taken indoors. FIG. 2(a) illustrates a state of the sheet during the day. FIG. 2(b) illustrates a state of the sheet during the evening. FIG. 2(c) illustrates a state of the sheet during the night.

FIG. 3 is a diagram for describing an embodiment in which a light blocking privacy sheet for a window pane according to an embodiment of the present invention is attached to a window pane using magnet pieces.

FIG. 4 is a diagram for describing an embodiment in which a light blocking privacy sheet for a window pane according to an embodiment of the present invention is attached to a window pane using magnet pieces.

### DESCRIPTION OF EMBODIMENTS

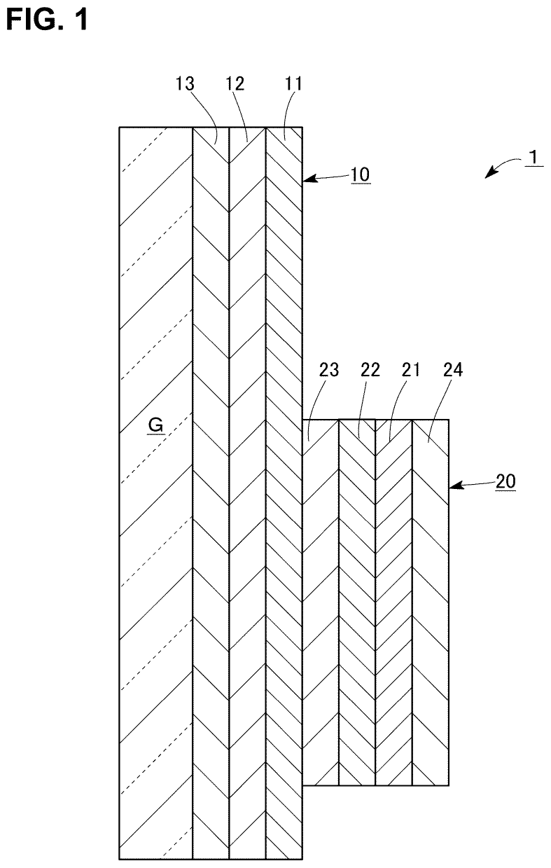

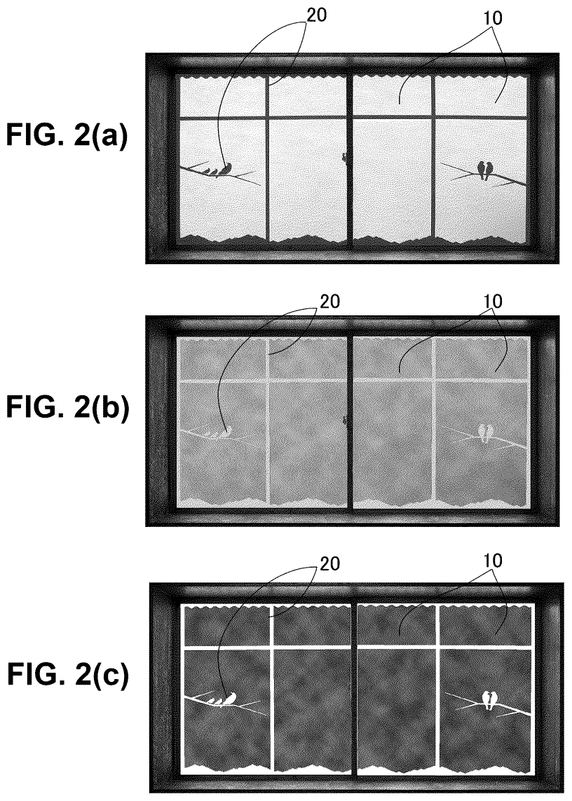

Embodiments pertaining to a light blocking privacy sheet for a window pane according to the present invention will be described below with reference to FIGS. 1 and 2. It should be noted that the present invention is in no way intended to be limited to the embodiments described below and the configurations illustrated in the accompanying drawings.

### Overall Configuration

FIG. 1 is a cross-sectional view of a light blocking privacy sheet for a window pane according to an embodiment of the present invention.

The light blocking privacy sheet 1 for a window pane is attached to a surface of a window pane G. The window pane G is, for example, of houses, office buildings, other constructions, and the like. As illustrated in FIG. 1, the light blocking privacy sheet 1 for a window pane according to the present invention includes a first sheet 10 and a second sheet 20.

Each constituent element of the light blocking privacy sheet 1 for a window pane will be described in detail below.

### First Sheet

The first sheet 10, which is opaque or translucent, is attached to a window pane. As illustrated in FIG. 1, the first sheet 10 includes a base layer 11, a resin layer 12, and an adhesive layer 13, which are stacked. The first sheet 10 is preferably configured to have a shading ratio of 30 to 85%. The shading ratio of the first sheet 10 is assumed to be the overall shading ratio of the base layer 11, the resin layer 12, and the adhesive layer 13. If the shading ratio is less than 30%, the light blocking effect and the privacy protection effect are less likely to be obtained. If the shading ratio is more than 85%, design properties produced by the second sheet 20 such as those that provide figures in shadow play are less likely to be obtained. Although, in this embodiment, the first sheet 10 is attached throughout a surface of the window pane G, the size and attachment position of the first sheet 10 are not particularly limited, and may be determined, as appropriate, depending on the range in which light blocking or privacy protection is desired.

As used herein, the term “shading ratio” refers to the percentage of visible light blocked (throughout the specification). The “shading ratio” may be measured in accordance with JIS L 1055 A or using a general-purpose visible light transmittance measurement device.

The base layer 11 is an opaque or translucent layer having light blocking properties. The base layer 11 preferably has any of a cloth, a nonwoven fabric, and a synthetic resin film, synthetic resin sheet, and synthetic resin plate made of a polyolefin resin, acrylic resin, polycarbonate resin, polystyrene resin, polyvinyl chloride resin, or the like. Of them, a cloth and nonwoven fabric are particularly preferable. The cloth and nonwoven fabric may be a mesh sheet. A frosted glass-like pattern or the like may be printed on the synthetic resin film, synthetic resin sheet, and synthetic resin plate to make the film, sheet, and plate translucent. A mesh, dot, check, or stripe pattern or the like may be printed on a portion of the synthetic resin film, synthetic resin sheet, and synthetic resin plate. The color of the base layer 11 is preferably a light color such as white, pink, cream, or light blue, particularly preferably white. By utilizing such materials and colors, light blocking properties and a privacy protection function are exhibited. Furthermore, when seen indoors during the day, the first sheet 10 entirely appears whitish in color due to the sunlight. When seen indoors during the night, the first sheet 10 appears blackish such as navy blue, ultramarine blue, or dark gray in color due to an influence of a change in the color of the outside. Therefore, the lightness and darkness of the first sheet 10 can appear to be reversed, depending on a difference between indoor lightness and outdoor lightness. In the case in which the first sheet 10 is made of a white cloth or nonwoven fabric, light can be introduced into a room to the extent that the inside of the room is not too dark. Thus, the light blocking privacy sheet 1 can be used instead of a lace curtain.

As illustrated in FIG. 1, the resin layer 12 is formed between the base layer 11 and the adhesive layer 13. The resin layer 12 is preferably made of substantially a transparent material, examples of which include a polyolefin resin, acrylic resin, polycarbonate resin, polystyrene resin, and polyvinyl chloride resin. The resin layer 12 is provided by lamination or the like in order to prevent a material for the adhesive layer 13 from penetrating into the base layer 11 in the case in which the base layer 11 is made of a cloth or nonwoven fabric. Therefore, in the case in which the base layer 11 is made of a synthetic resin film, synthetic resin sheet, or synthetic resin plate, the resin layer 12 can be removed.

The adhesive layer 13 is adhesive to the window pane G or can stick to the window pane G by a suction effect. Examples of the adhesive agent include, but are not limited to, acrylic adhesive agents, urethane adhesive agents, silicone adhesive agents, rubber adhesive agents, and polyester adhesive agents. These adhesive agents may be used alone or in combination. Alternatively, a foam resin sheet piece having the ability to stick by a suction effect may be used. The adhesive layer 13 may have high adhesiveness or removability. In the case in which the adhesive layer 13 has high adhesiveness, if the window pane G is broken after the first sheet 10 is attached to the window pane G, the window pane G can be prevented from scattering. In the case in which the adhesive layer 13 has removability, if, when the first sheet 10 is attached to the window pane G, a trouble such as entry of bubbles occurs, the adhesive layer 13 can be temporarily removed and then easily attached again. The first sheet 10 can be attached to the pane surface by a method of using the static cling effect of a polypropylene resin or vinyl chloride resin, or the effect of causing a plasticizer to bleed from the inside of the sheet, or by a wet application method.

The method of attaching the first sheet 10 to the window pane G is, for example, not limited to so-called dry application by which the adhesive layer 13 is directly attached to the window pane G, and may be so-called wet application by which an application liquid such as an aqueous surfactant solution is sprayed onto the adhesive layer 13 and the window pane G before the adhesive layer 13 is attached to the window pane G. The adhesive layer 13 preferably has at least such an adhesion strength that after the first sheet 10 is attached to the window pane G by wet application, the first sheet 10 does not come off the surface of the window pane G even if water no longer exists.

The adhesive layer 13 is not limited to being present throughout the first sheet 10, and may be present at only a portion of the first sheet 10. Specifically, the adhesive layer 13 may be provided at only a peripheral portion or four corners of the first sheet 10. Furthermore, although not illustrated, a release sheet may be provided on top of the adhesive layer 13. The adhesive layer 13 may be formed of other materials such as a double-sided adhesive tape.

### Second Sheet

The second sheet 20 is provided on top of a portion of the first sheet 10. As illustrated in FIG. 1, the second sheet 20 includes a colored layer 21, a light blocking layer 22, an adhesive layer 23, and a deglossing layer 24, which are stacked. The shading ratio of the second sheet 20 is higher than that of the first sheet 10, and is preferably at least 90%, more preferably at least 95%, and particularly preferably at least 98%. The shading ratio of the second sheet 20 is assumed to be the overall shading ratio of the colored layer 21, the light blocking layer 22, the adhesive layer 23, and the deglossing layer 24. If the shading ratio is less than 90%, design properties produced by the second sheet 20 such as those that provide figures in shadow play are less likely to be obtained.

The second sheet 20 is in the shape of a picture, graphic, pattern, and/or character. Specifically, examples of the shape include pictures of a human, animal, plant, and the like, graphics of a circle, star, heart, and the like, and patterns of a check, stripe, and the like. The shape of the second sheet 20 may not be previously determined, and the user may cut the second sheet 20 into their preferred shapes. Because the second sheet 20 has such a shape, design properties can be easily improved. In addition, the shape, position, and combination of the second sheet(s) 20 can be freely changed, depending on the size of a window or an individual's preference, resulting in an improvement in design flexibility.

The colored layer 21 is preferably made of a material such as a cloth, nonwoven fabric, synthetic resin film, synthetic resin sheet, synthetic paper, thin wood plate, or the like. The color of the colored layer 21 preferably has a light color such as white, pink, cream, or light blue, particularly preferably white. The color of the colored layer 21 is not particularly limited, and may be a color having an intermediate lightness, a black color, or the like, depending on a change in the color of the first sheet 10.

The light blocking layer 22 has light blocking properties. The light blocking layer 22 is preferably formed by layering a light blocking material such as a metal vapor deposition (e.g., aluminum vapor deposition), resin mixed with aluminum powder, aluminum coating, aluminum foil, white print, or nonwoven fabric. In the case in which the light blocking layer 22 is thus configured, even if the colored layer 21 has a light color such as white, then when the second sheet 20 is seen indoors, the second sheet 20 transmits substantially no sunlight and therefore appears dark in color such as dark gray or black during the day, and appears white or the like in color, which is the original color, without being affected by a change in the color of the outside during the night. As a result, lightness or darkness can differ between the second sheet 20 and the first sheet 10.

The adhesive layer 23 is adhesive to the first sheet 10 or can stick to the first sheet 10 by a suction effect. The adhesive layer 23 may have removability. Only the second sheet 20 can be removed with the first sheet 10 remaining attached, and the design of the second sheet 20 can be easily changed, depending on the season or mood. Specifically, examples of the adhesive agent include acrylic adhesive agents, urethane adhesive agents, silicone adhesive agents, rubber adhesive agents, and polyester adhesive agents. Alternatively, a foam resin sheet piece having the ability to stick by a suction effect can be used.

The adhesive layer 23 is not limited to being present throughout the second sheet 20, and may be present at only a portion of the second sheet 20. Specifically, the adhesive layer 23 may be provided at only a peripheral portion or four corners of the second sheet 20. Furthermore, although not illustrated, a release sheet may be provided on top of the adhesive layer 23. The adhesive layer 23 may be formed of other materials such as a double-sided adhesive tape.

The deglossing layer 24 is formed so as to cover the colored layer 21. The deglossing layer 24 is, for example, preferably made of a transparent resin or the like containing a deglossing material. Examples of the transparent resin include acrylic resins and thermoplastic resin layers. The deglossing material, which is also called a matte material or a gloss adjusting agent, is applied, depending on a surface of the colored layer 21. The deglossing layer 24 can protect the colored layer 21, thereby preventing the colored layer 21 from being scratched, released, discolored, and the like.

### Examples of Use

Examples of use of the light blocking privacy sheet 1 for a window pane thus configured will be described.

FIG. 2 illustrates comparative photographs of a light blocking privacy sheet for a window pane according to an embodiment of the present invention that are taken indoors. FIG. 2(a) illustrates a state of the sheet during the day. FIG. 2(b) illustrates a state of the sheet during the evening. FIG. 2(c) illustrates a state of the sheet during the night. In this embodiment, the first sheet 10 is attached to an entire surface of the window pane G facing the inside of a room, and the second sheet 20 is provided on top of the first sheet 10. In this embodiment, the second sheet 20 is formed in the shape of a bird, a branch of a tree, a band, and the like.

As illustrated in FIG. 2(a), the first sheet 10 and the second sheet 20, when irradiated with sunlight of about 10,000 to 100, 000 lux during the day, appear whitish and dark gray or black, respectively, in color. Therefore, for example, design properties that provide figures in shadow play can be obtained. As illustrated in FIG. 2(b), the sunlight becomes gradually weaker from the evening, and therefore, the color of the first sheet 10 changes from the daytime whitish color to a bluish color. The original color (e.g., white) of the second sheet 20 starts appearing. As illustrated in FIG. 2(c), during the night, the inside of a room has an illuminance of about 1000 lux and is lighter than the outside, and therefore, the original color (e.g., white) of the second sheet 20 clearly appears. The color of the first sheet 10 changes to navy black, ultramarine black, or dark gray which is close to black, depending on a change in the color of the outside of the room. In this embodiment, the first sheet 10 is made of a white, thin nonwoven fabric, and therefore, appears to be a white mist. Thus, for the light blocking privacy sheet 1 for a window pane, the lightness and darkness of the first sheet 10 and the second sheet 20 can appear to be reversed, depending on a difference between indoor lightness and outdoor lightness.

When the light blocking privacy sheet 1 is seen outdoors, lightness and darkness appear to be reversed compared to when the light blocking privacy sheet 1 is seen indoors. When seen outdoors during the day, the first sheet 10 appears dark gray or black in color while the second sheet 20 appears whitish in color. When seen outdoors during the night, the first sheet 10 appears whitish in color while the second sheet 20 appears dark gray or black in color. Therefore, for example, design properties that provide figures in shadow play can be perceived outdoors.

In the foregoing, a light blocking privacy sheet for a window pane according to an embodiment of the present invention has been described. The present invention is not limited to the configurations described in the above embodiment. Changes and modifications can be made to the configurations as appropriate without departing from the spirit and scope of the present invention.

For example, the first sheet 10 may be attached to the window pane G using a magnet piece such as a rubber magnet instead of the adhesive layer 13.

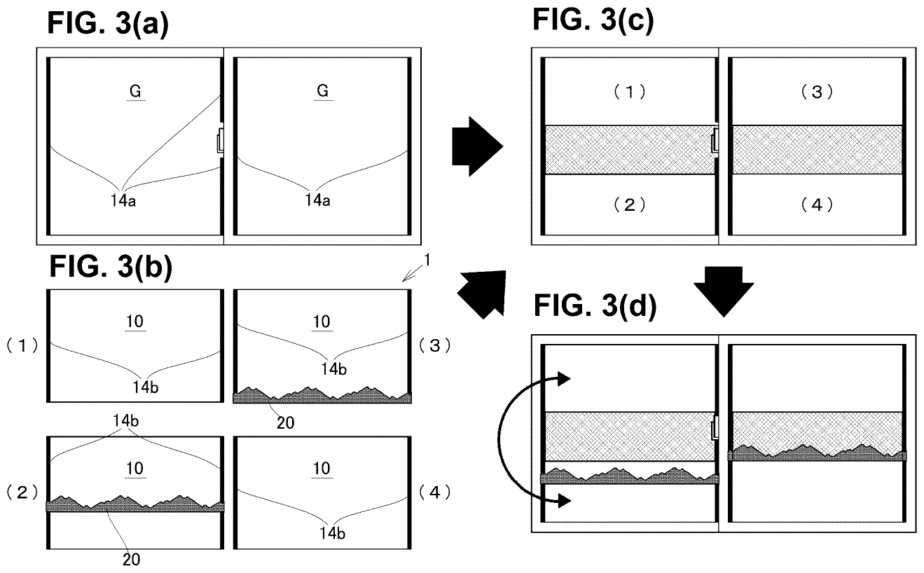

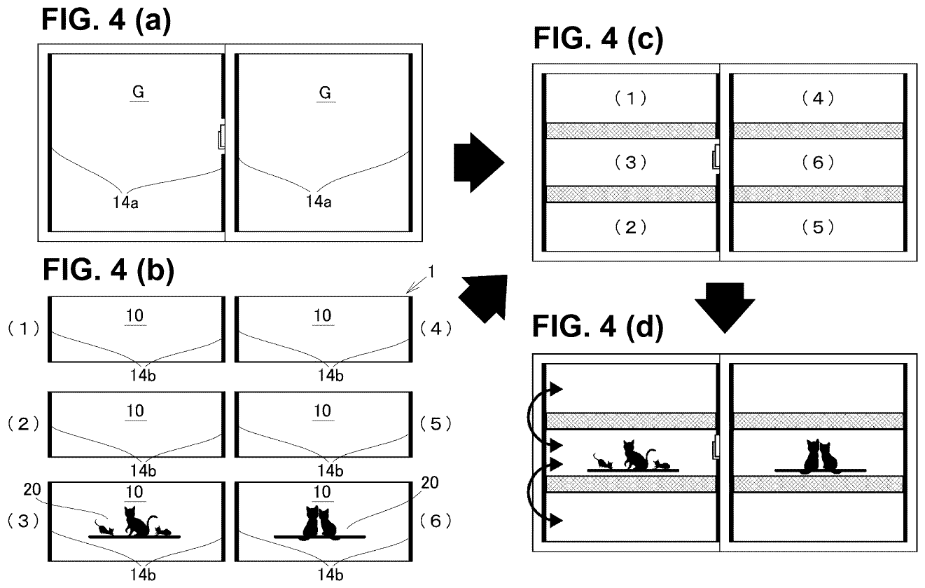

Specifically, as illustrated in FIG. 3(a) and FIG. 4(a), magnet pieces 14a are connected to a surface of a window pane G, for example, using an adhesive, along a stile and a meeting stile of a window sash. In this case, a magnet piece 14a may be absent at a position of a crescent-type lock keeper, i.e., may have a discontinuous portion at that position, so that the magnet piece 14a does not interfere with the crescent-type lock keeper. In the light blocking privacy sheet 1 for a window pane, as illustrated in FIG. 3(b), four sheets (1) to (4) are used as the first sheet 10 (the second sheet 20 is provided on the sheets (2) and (3) of the four sheets), or as illustrated in FIG. 4(b), six sheets (1) to (6) are used as the first sheet 10 (the second sheet 20 is provided on the sheets (3) and (6) of the six sheets), and a magnet piece 14b that is attached to a magnet piece 14a by magnetism is connected to either side of each sheet, for example, using an adhesive. The sheets may, for example, be arranged at positions indicated by FIG. 3(c) and 4(c) (the arrangement of the sheets may be changed as appropriate). As a result, as illustrated in FIG. 3 (d) and 4(d), the first sheet 10 may be attached to a window pane G by the magnet pieces 14b being attached to the magnet pieces 14a by magnetism.

### INDUSTRIAL APPLICABILITY

The light blocking privacy sheet for a window pane according to the present invention has appropriate light blocking properties and privacy protection function, higher design flexibility, and design properties that are exhibited no matter whether it is during the day or night and no matter whether the sheet is seen indoors or outdoors, and therefore, is applicable to a wide range of pane surfaces of windows of constructions and the like.

### REFERENCE SIGNS LIST

1 LIGHT BLOCKING BLIND SHEET FOR WINDOW PANE
10 FIRST SHEET
11 BASE LAYER
12 RESIN LAYER
13 ADHESIVE LAYER
14a MAGNET PIECE
14b MAGNET PIECE
20 SECOND SHEET
21 COLORED LAYER
22 LIGHT BLOCKING LAYER
23 ADHESIVE LAYER
24 DEGLOSSING LAYER
G WINDOW PANE

1. A light blocking privacy sheet configured to be attached to a surface of a window pane, the sheet comprising:
an opaque or translucent first sheet configured to be attached to the window pane; and
a second sheet layered on a portion of the first sheet, wherein
the second sheet has a shading ratio higher than that of the first sheet, and
lightness and darkness of the first and second sheets appear to be reversed, depending on a difference between indoor lightness and outdoor lightness.

2. The light blocking privacy sheet according to claim 1, wherein
the shading ratio of the first sheet is 30 to 85%.

3. The light blocking privacy sheet according to claim 1, wherein
the shading ratio of the second sheet is at least 90%.

4. The light blocking privacy sheet according to claim 1, wherein
the first sheet has any of a cloth, nonwoven fabric, synthetic resin film, synthetic resin sheet, and synthetic resin plate.

5. The light blocking privacy sheet according to claim 1, wherein
the second sheet is formed in the shape of a picture, graphic, pattern, and/or character.

6. The light blocking privacy sheet according to claim 2, wherein
the first sheet has any of a cloth, nonwoven fabric, synthetic resin film, synthetic resin sheet, and synthetic resin plate.

7. The light blocking privacy sheet according to claim 3, wherein
the first sheet has any of a cloth, nonwoven fabric, synthetic resin film, synthetic resin sheet, and synthetic resin plate.

8. The light blocking privacy sheet according to claim 2, wherein the second sheet is formed in the shape of a picture, graphic, pattern, and/or character.

9. The light blocking privacy sheet according to claim 3, wherein the second sheet is formed in the shape of a picture, graphic, pattern, and/or character.
